(19) United States
(12) Patent Application Publication
(10) Pub. No.: US 2026/0135608 A1
(43) Pub. Date: May 14, 2026

(54) BEAM ALIGNMENT FOR WIRELESS NETWORKS BASED ON PRE-TRAINED MACHINE LEARNING MODEL AND ANGLE OF ARRIVAL

(71) Applicant: Nokia Technologies Oy, Espoo (FI)

(72) Inventors: Andrea BONFANTE, Massy (FR); Qiping ZHU, Naperville, IL (US); Frederick VOOK, Naperville, IL (US)

(21) Appl. No.: 18/860,915

(22) PCT Filed: Apr. 29, 2022
(86) PCT No.: PCT/EP2022/061502

§ 371 Date: Oct. 28, 2024

(51) Int. Cl. H04B 7/06; H04B 7/0408; H04B 7/08; H04W 24/02

(52) U.S. Cl. CPC H04B 7/06962; H04B 7/0408; H04B 7/088; H04W 24/02

(57) ABSTRACT

A method includes determining signal measurements for signals received for a plurality of first beams; determining a beam index and estimated angle of arrival for one or more network node transmit second beams based on the signal measurements for a set of one or more first beams and position information for the user device; determining for one or more of the network node transmit second beams, an associated user device receive second beam, wherein the associated user device receive second beam is at least one of a beam from a codebook that has an angle of arrival that most closely matches the estimated angle of arrival of the network node transmit second beam, or a beam having beam weights calculated based on the estimated angle of arrival for the network node transmit second beam; and controlling transmitting the beam index for the one or more network node transmit second beams.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include determining, by a user device, signal measurements for signals received from a network node for a plurality of first beams; determining, by the user device, a beam index and an estimated angle of arrival for one or more network node transmit second beams based on the signal measurements for a set of one or more first beams and position information for the user device; determining, by the user device for one or more of the network node transmit second beams, an associated user device receive second beam, wherein the associated user device receive second beam is at least one of a beam from a codebook that has an angle of arrival that most closely matches the estimated angle of arrival of the network node transmit second beam, or a beam having beam weights calculated based on the estimated angle of arrival for the network node transmit second beam; and controlling transmitting, by the user device to the network node, the beam index for the one or more network node transmit second beams.

According to an example embodiment, a method may include controlling transmitting, by a network node to a user device, signals via a plurality of first beams; controlling receiving, by the network node from the user device, signal measurements for a set of one or more of the first beams; controlling receiving, by the network node, position information for the user device; determining, by the network node, a beam index and an estimated angle of arrival for one or more network node transmit second beams based on the signal measurements for the set of one or more first beams and position information for the user device; and controlling transmitting, by the network node to the user device, information indicating the estimated angle of arrival of the one or more network node transmit second beams.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a user device or UE.

FIG. 3 is a flow chart illustrating operation of a gNB or network node.

FIG. 4 is a diagram illustrating training of a machine learning (ML) model by a network node or gNB or other network entity.

FIG. 5 is a block diagram illustrating operation of a user device (or UE).

FIG. 6 is a diagram illustrating operation of a gNB or network node.

FIG. 7 is a diagram illustrating training of a machine learning (ML) model.

FIG. 8 is a diagram illustrating gNB beams and UE beams.

FIG. 9 is a diagram illustrating ML model inference phase at a UE or user device.

FIG. 10 is a diagram illustrating a representation of gNB and UE codebooks for the second beam sweeping stage.

FIG. 11 is a block diagram of a wireless station or node (e.g., network node, user node or UE, relay node, or other node).

### DETAILED DESCRIPTION

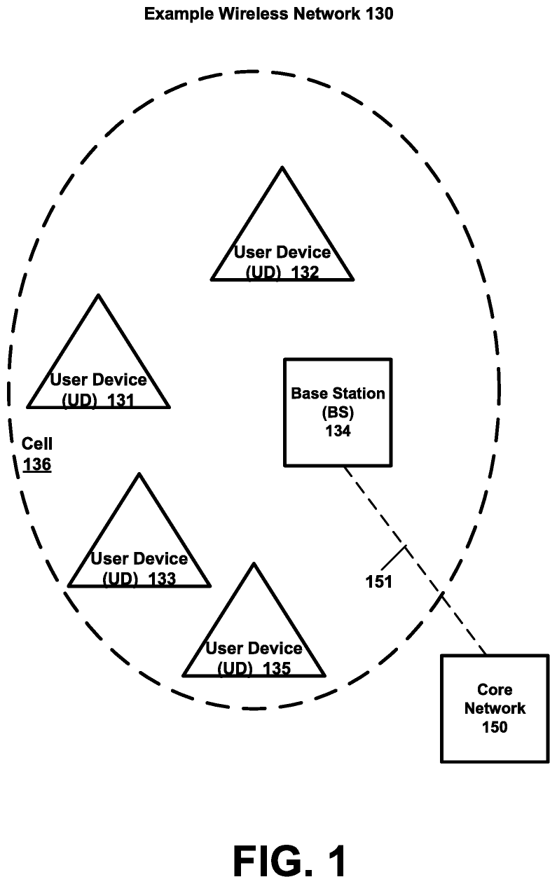

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e)Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is anew data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10−5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as 5G (New Radio (NR)), cmWave, and/or mmWave band networks, IoT, MTC, eMTC, eMBB, URLLC, 6G, etc., or any other wireless network or wireless technology. These example networks, technologies or data service types are provided only as illustrative examples.

Beamforming may be used for transmitting and/or receiving a signal. By adjusting a weight (e.g., amplitude and/or phase) of each antenna element of an antenna panel or antenna system, a node (e.g., network node and/or UE) may provide directivity in which transmission power may be directed in a specific direction via beamforming, for transmitting a signal. Thus, beamforming may allow a node to provide transmitter-side directivity, where a transmitting node (e.g., a gNB or network node, or a UE or user device) may apply a weight or a set of weights to antenna elements to form a beam for transmitting a signal. Likewise, beamforming may also be used to provide receiver-side directivity, where a receiving node may apply a weight or set of weights to antenna elements to form a receive beam. Because each beam may typically cover only a limited area or direction, multiple beams (e.g., with each beam pointed in a different direction) are typically required to cover a full range of directions. Example beams may include synchronization signal block reference signal (SSB) beams, and channel state information reference signal (CSI-RS) beams, where each reference signal is associated with a different beam, as it may point in a different direction. A gNB or network node may utilize multiple beams to cover the entire service area, and one or a subset of those beams may be associated with a UE (e.g., may point in a direction towards the UE and/or may be a strongest beam (or best beam, such as the beam having a highest RSRP measurement) for communication with the UE).

Wide beams may be wider (have a wider or larger angle, to cover a larger range of angular directions) than narrow beams. Wide beams may include, e.g., SSB beams or CSI-RS beams, while narrow beams may typically include CSI-RS beams.

3GPP beam management may include procedures P1, P2 and P3 that are briefly summarized as follows:

P1 (gNB wide beam sweeping): The gNB sweeps through a set of wide angular beams assigned to different SSB/CSI-RS resources, while transmitting a signal (e.g., a SSB or a CSI-RS signal) on an associated resource of each beam. Sweeping may refer to the node generating a sequence of beams across a range of directions or possibly covering all directions. After measuring the UE performs signal measurement (e.g., the UE measuring reference signal receive power (RSRP)) on different SSBs (or for different SSB beams), the UE requests access to the gNB, by transmitting (e.g., by transmitting a random access preamble) in a time-frequency location that corresponds to the SSB of the best beam.

P2 (gNB narrow beam sweeping): The gNB performs beam sweeping through a set of narrow beams assigned to different CSI-RS resources that cover the wide angular space of the SSB beam adopted (or indicated by the UE as the best wide beam) in P1. The UE performs signal measurement (e.g., measures RSRP of signals transmitted by gNB via the narrow beams) and reports to the gNB the RSRP measurements of one or more of the best or strongest gNB (or network node) transmit narrow beams using a CSI-report. The gNB may select the best gNB transmit narrow beam based on the RSRP measurements.

P3 (UE beam sweeping): the gNB uses the optimal or best gNB transmit narrow beam selected from P2 to transmit multiple CSI-RSs (multiple narrow or CSI-RS beams) while the UE sweeps through a set of UE receive narrow beams to refine the UE beam direction. The UE can make a selection of the best UE receive narrow beam based on the RSRP measurements and communicate the results to gNB.

Therefore, during data transmission the gNB (or network node) uses the best or strongest (e.g., a beam or reference signal having a highest RSRP) narrow beam found in P2 while the UE uses the best or strongest (e.g., beam or reference signal having a highest RSRP) beam found in P3.

The three procedures (P1, P2 and P3) are inefficient for two main reasons. On the one hand, sweeping all the beams in each of P1, P2 and P3 is time-consuming. This significantly increases the system's latency during the initial access operation. Secondly, the above procedures significantly increase measurement reporting, which increases signalling overhead. This reduces the system throughput and spectral efficiency. For example, data transmission opportunities may be reduced due to the resources employed for signalling and obtaining the beam measurements.

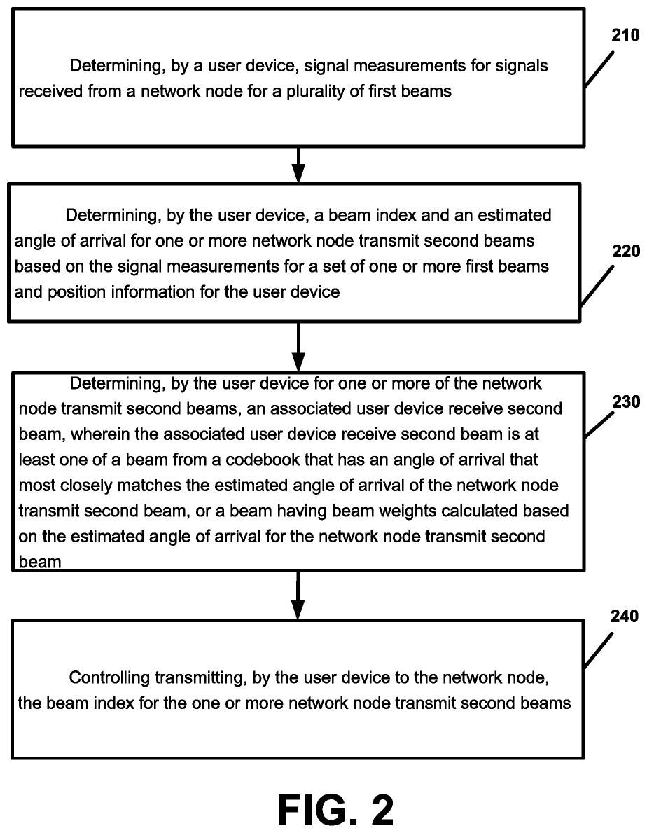

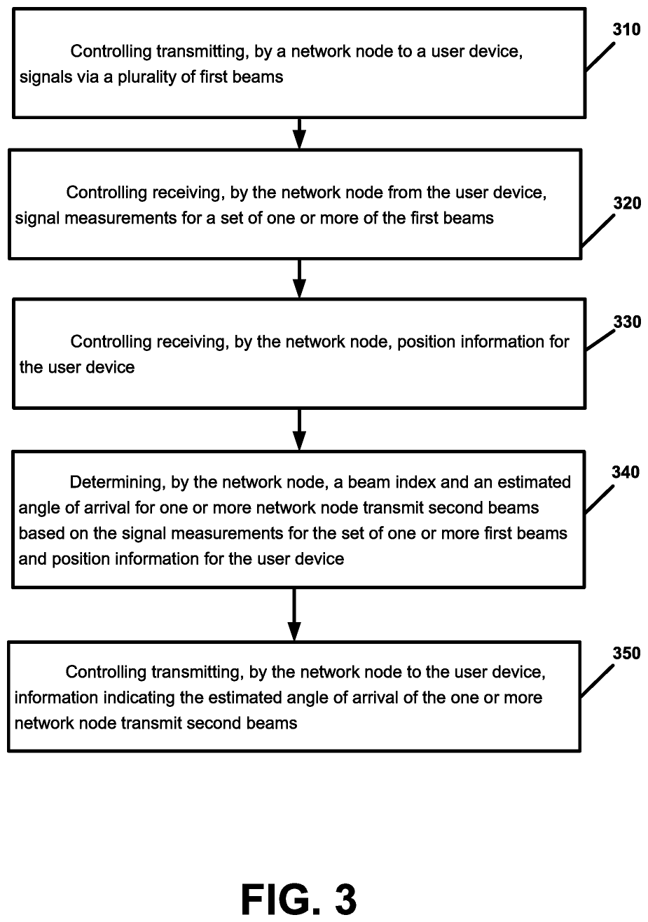

Techniques of methods of FIG. 2 and/or FIG. 3 may be used, for example, to replace procedures P2 and/or P3 with a new beam management procedure that uses machine learning (ML)-driven outputs to identify or at least narrow down the number of signal (e.g., CSI-RSs) measurements used to find the best receive (Rx) and transmit (Tx) beams. These techniques may, for example, speed up the beam alignment procedure and may reduce the measurement and signalling overhead and/or enabling more accurate selection of the transmit and/or receive beams, and may also be applied to UEs having different configurations of grid of beams.

FIG. 2 is a flow chart illustrating operation of a user device or UE. Operation 210 includes determining, by a user device (e.g., UE), signal measurements (e.g., measuring reference signal received power (RSRP)) for signals (e.g., for reference signals, such as synchronization signal block (SSB) or channel state information-reference signal (CSI-RS) signals) received from a network node for a plurality of first beams (e.g., for a plurality of wide beams or SSB beams). Operation 220 includes determining, by the user device, a beam index and an estimated angle of arrival (AoA) for one or more network node transmit second beams (e.g., for one or more network node or gNB transmit narrow beams or gNB transmit CSI-RS beams) based on the signal measurements for a set of one or more first beams and position information for the user device. Operation 230 includes determining, by the user device for one or more of the network node transmit second beams, an associated user device receive second beam (e.g., an associated UE receive narrow beam or an associated UE receive CSI-RS beam), wherein the associated user device receive second beam is at least one of a beam from a codebook that has an angle of arrival that most closely matches the estimated angle of arrival of the network node transmit second beam, or a beam having beam weights calculated based on the estimated angle of arrival for the network node transmit second beam. And, operation 240 includes controlling transmitting, by the user device to the network node, the beam index for the one or more network node transmit second beams. Thus, for example, the associated UE receive narrow beam or associated user device receive second beam may be determined two ways, for example: 1) a beam of a codebook, that has an angle of arrival that most closely matches the estimated AoA of the network node transmit second beam; and/or 2) by calculating the beam weights based on the estimated AoA for the network node transmit second beam.

With respect to the method of FIG. 2, wherein the determining a beam index and an estimated angle of arrival may include: providing, by the user device, the signal measurements for a set of one or more first beams and the position information for the user device as inputs of a pre-trained machine learning model (e.g., which may be a general machine learning model that was trained by the network node (or gNB) or another entity) enabled (e.g., installed and running or executing) on the user device (or UE); controlling receiving, by the user device as an output from the pre-trained machine learning model, a beam index and an estimated angle of arrival for one or more network node transmit second beams (e.g., the machine learning model may output a label that indicates or identifies the beam index and estimated AoA for one or more network node transmit second beams (e.g., for one or more gNB transmit narrow beams or gNB transmit CSI-RS beams).

With respect to the method of FIG. 2, the method may further include: controlling receiving, by the user device from the network node, the pre-trained machine learning model; selecting, by the user device, the set of one or more first beams based on signal measurements performed by the user device for a plurality of first beams (e.g., selecting one or more of the first beams (e.g., SSB beams or wide beams) that have a highest RSRP); and, determining, by the user device, position information for the user device (e.g., the user device or UE may determine its position information (that identifies the position or location of the user device or UE) by either, receiving its position information from a location management function (LMF) or other node or entity, or by calculating its own position information based on received signals and/or received information).

With respect to the method of FIG. 2, the method may further include determining, by the user device based on signal measurements of the one or more network node transmit second beams received from the network node, a best or a selected network node transmit second beam; and controlling transmitting, by the user device to the network node, a beam index of the best or the selected network node transmit second beam.

With respect to the method of FIG. 2, the determining, by the user device based on signal measurements of the one or more network node transmit second beams received from the network node, a best or a selected network node transmit second beam may include performing the following for each of the one or more one network node transmit second beams: controlling receiving, by the user device from the network node, a signal via a beam pair that includes the network node transmit second beam and the associated user device receive second beam; and measuring, by the user device, a signal parameter (e.g., RSRP) of the received signal; and selecting, by the user device, among the plurality of network node transmit second beams, a best or a selected (e.g., having a highest RSRP, or other signal parameter) network node transmit second beam (e.g., a gNB transmit narrow beam or gNB transmit CSI-RS beam) based on the measuring.

With respect to the method of FIG. 2, the method may further include controlling receiving data, by the user device from the network node, via a beam pair that includes the best or selected network node transmit second beam and the associated user device receive second beam.

With respect to the method of FIG. 2, the pre-trained machine learning model may not be specific to the user device, and/or may not be specific to the receive beam configuration of the user device, may be general for multiple user devices, and/or may be general or applicable for different receive beam configurations of multiple user devices, and/or may be trained based on information provided by a plurality of user devices.

With respect to the method of FIG. 2, the angle of arrival may include both an azimuth angle of arrival and an elevation angle of arrival, the method may further include: converting, by the user device, the angle of arrival from a first coordinate system to a second coordinate system based on a transformation matrix.

With respect to the method of FIG. 2, the method may further include controlling transmitting, by the user device, information to the network node to enable the network node to perform pre-training of the machine learning model.

With respect to the method of FIG. 2, the first beams may include wide beams; and/or the second beams may include narrow beams that are narrower than the wide beams.

With respect to the method of FIG. 2, the first beams may include wide beams; the network node transmit second beams may include narrow beams; and the user device receive second beam may include a narrow beam; wherein wide beams have a wider beam width than the narrow beams.

With respect to the method of FIG. 2, the first beams may include synchronization signal block (SSB) beams or channel state information-reference signal (CSI-RS) beams; the network node transmit second beams may include channel state information-reference signal (CSI-RS) beams; and the user device receive second beam may include a channel state information-reference signal (CSI-RS) beam.

With respect to the method of FIG. 2, the signal measurements may include a reference signal receive power (RSRP) measurement of reference signals.

FIG. 3 is a flow chart illustrating operation of a network node (e.g., gNB). Operation 310 includes controlling transmitting, by a network node to a user device (e.g., UE), signals via a plurality of first beams (e.g., a plurality of wide beams or SSB beams). Operation 320 includes controlling receiving, by the network node from the user device, signal measurements (e.g., RSRP measurements or other signal measurements) for a set of one or more of the first beams. Operation 330 includes controlling receiving, by the network node, position information for the user device. Operation 340 includes determining, by the network node, a beam index and an estimated angle of arrival for one or more network node transmit second beams (e.g., gNB transmit narrow beams or gNB transmit CSI-RS beams) based on the signal measurements for the set of one or more first beams and position information for the user device. And, operation 350 includes controlling transmitting, by the network node to the user device, information indicating the estimated angle of arrival of the one or more network node transmit second beams.

The method of FIG. 3 may further include controlling receiving, by the network node from the user device (or UE), the beam index of the best network node transmit second beams of one or more network node transmit second beams.

With respect to the method of FIG. 3, the determining a beam index and an estimated angle of arrival may include: providing, by the network node, the signal measurements for a set of one or more first beams and the position information for the user device as inputs to a trained machine learning model enabled on the network node; and, controlling receiving, by the network node as an output from the trained machine learning model, a beam index and an estimated angle of arrival for one or more network node transmit second beams.

With respect to the method of FIG. 3, the method may further include controlling transmitting, by the network node, signals via the one or more network node transmit second beams indicated by the pre-trained machine learning model; and controlling receiving, by the network node from the user device, a beam index of a best or a selected network node transmit second beam of the one or more network node transmit second beams.

With respect to the method of FIG. 3, the method may further include controlling transmitting data, by the network node to the user device, via a beam pair that includes the best or selected network node transmit second beam and an associated user device receive second beam.

With respect to the method of FIG. 3, the pre-trained machine learning model may not be specific to the user device, or may not be specific to the receive beam configuration of the user device, may be general for multiple user devices, and/or may be trained based on information provided by a plurality of user devices.

With respect to the method of FIG. 3, the first beams may include wide beams; and/or the second beams may include narrow beams that are narrower than the wide beams.

With respect to the method of FIG. 3, the first beams may include wide beams; the network node transmit second beams may include narrow beams; and the user device receive second beam may include a narrow beam; wherein wide beams have a wider beam width than the narrow beam

With respect to the method of FIG. 3, the first beams may include synchronization signal block (SSB) beams or channel state information-reference signal (CSI-RS) beams; the network node transmit second beams may include channel state information-reference signal (CSI-RS) beams; and the user device receive second beam may include a channel state information-reference signal (CSI-RS) beam.

With respect to the method of FIG. 3, the signal measurements may include a reference signal receive power (RSRP) measurement of reference signals.

With respect to the method of FIG. 3, the method may further include training, based on information received from a plurality of user devices, a machine learning model to obtain the trained machine learning model.

With respect to the method of FIG. 3, the method may further include receiving, by the network node information from a plurality of user devices, including signal measurements for a set of one or more first beams and position information for the user device; and training, based on information received from the plurality of user devices, the machine learning model to obtain the pre-trained machine learning model.

With respect to the method of FIG. 3, the angle of arrival (AoA) may include both an azimuth angle of arrival and an elevation angle of arrival, the method may further include: converting, by the network node, the angle of arrival from a first coordinate system to a second coordinate system based on a transformation matrix.

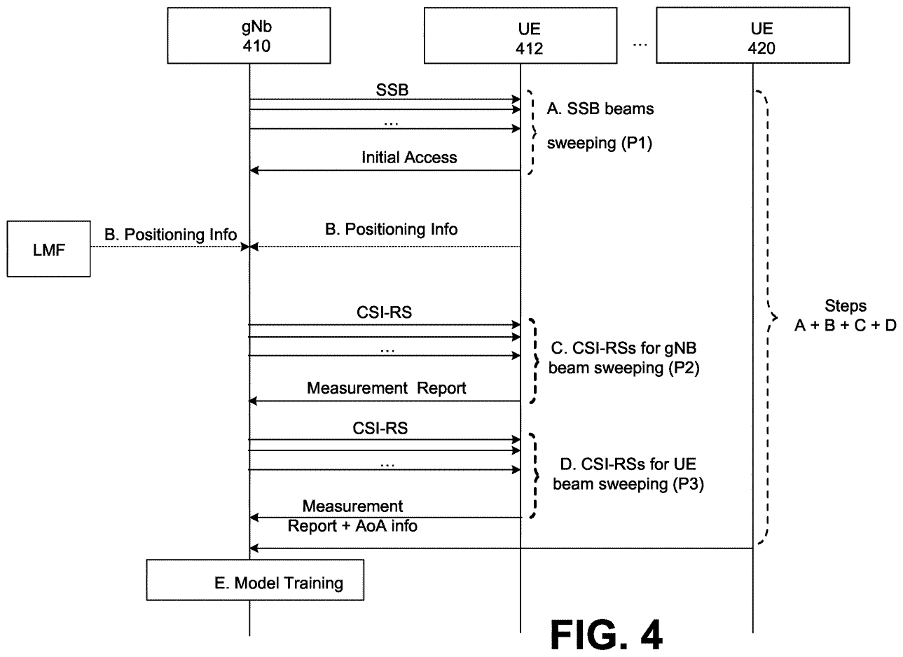

FIGS. 4-11 and associated text illustrate and/or describe one or more further features and/or details that may be provided or included within or as part of the methods of FIGS. 2 and/or 3.

### Model Training at the gNB

FIG. 4 is a diagram illustrating training of a machine learning (ML) model by a network node or gNB or other network entity. As shown in FIG. 4, a gNB 410 may be in communication with one or more UEs, including UE 412. The UEs may provide information to the gNB 410, and the gNB may train a ML model, to be used on or by one or more UEs. Training input data: RSRP measurements of N best SSB (or wide) beams measured by UE at P1, and position information of UE. The training of the ML model may use a supervised learning approach: input data (RSRP measurements of N best SSB or wide beams, and UE position information) and labels (as outputs being trained), that represent value of a variable, to train the ML model parameters. Labels—represent indices of the best gNB transmit (TX) beam and estimated AoA for each of those beams, typically reported from UE. ML model training may be performed by gNB, based on information received from multiple (or a plurality of) UEs.

Step A: The UE 412 performs the P1 procedure for the initial access to the gNB 410. During the P1, the UE measures RSRPs from SSB beams for beam selection. At the end of P1, the UE 412 may request access to gNB 410 by transmitting in a time-frequency location that corresponds to the best SSB beam. Then, the gNB 410 may configure the UE 412 to send back the indices (or indexes) of the best N SSB beams along with their associated N RSRPs for data collection. N may be set to a value that depends by the UE capability.

Step B: The gNB 410 requests the UE location (UE position information) from the UE or with network-based positioning methods. The gNB may obtain UE position information of UE 412 from UE 412, from a location management function (LMF) of the network, or other technique.

Step C: The gNB 410 executes P2 and configures the UE to measure the CSI-RSs (or to measure RSRP of CSI-RS beams or reference signals) while sweeping a small set of narrow (e.g., CSI-RS) beams around the best (e.g., SSB or wide) beam of P1. The UE sends the CSI-RS (e.g., narrow beam) measurement reports back to the gNB, which identifies the best narrow (or CSI-RS) beam (e.g., the best gNB transmit narrow beam) that, e.g., achieves the highest RSRP from the list of CSI-RS measurements.

Step D: The gNB executes P3 and uses the best narrow beam (best gNB transmit narrow beam) of P2 to transmit several CSI-RSs while the UE sweeps the UE receive narrow (e.g., CSI-RS) beams to identify the best UE receive narrow (e.g., best UE receive CSI-RS) beam having or achieving the best (highest) RSRP. During P3, the UE may estimate the AoA for each Rx beam with beam sweeping and reports to the gNB the RSRP measured on the best Rx beam together with the associated AoA information. The AoA may be reported either in the global coordinate system or a local coordinate system as follows: If the UE reports the AoA in the global coordinate system, the UE may convert the AoA from the local coordinate system to the global coordinate system with a transformation matrix signalled or provided by the gNB.

If the UE reports the AoA in the local coordinate system, the UE may report to the gNB the AoA expressed in the local coordinate system in addition to the UE device orientation information. The gNB, may convert the AoA to a global coordinate system by using the device orientation to compute the transformation matrix. For the UEs supporting vertical beamforming, two AoAs in azimuth and elevation directions may be signalled or provided for the best beam pair.

Step E: Supervised learning approach, or other technique, may be employed to train the ML model considering (or based upon) the data collected at the gNB from multiple UEs. For each UE the RSRP beam (e.g., SSB) measurements from P1 and the UE position information (UE location) may be used as input data samples of the ML model. The best transmit beam index in P2 and the associated estimated AoA in P3 (e.g., which may be converted to a predefined grid) may be used as output data samples (label), for each set of inputs (RSRP beam measurements for SSB beams or wide beams and UE position information). Other UEs (such as UE 420) may perform a similar or same procedure.

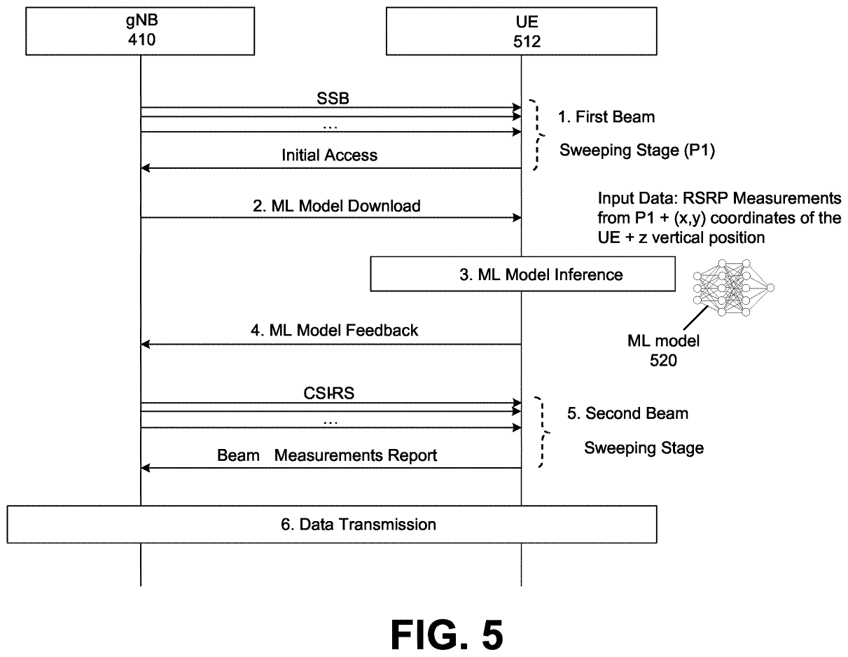

FIG. 5 is a block diagram illustrating operation of a user device (or UE). Steps 1-6 are shown in FIG. 5.

### Model Inference at the UE

Step 1: A new UE 512 (which may or may not have provided data or information to be used for ML model training) performs the P1 procedure for the initial access to the gNB 410. Thus, it is not necessary for the UE that receives and uses the ML model to have provided information or data for training of the ML model, as the ML model is general, and can be used by many or all UEs.

During P1, the UE measures RSRPs of SSB (or wide) beams, and then requests access to gNB 410 by transmitting a random access (RACH) preamble (to establish a connection with the gNB 410) in a time-frequency location that corresponds to the best (e.g., having a highest RSRP, as measured by UE 512) SSB beam. After connecting to the gNB, the gNB may configure the UE to perform measurements and report them in accordance with the measurement configuration. In a measurement report, there is the option to include the SSB based measurement results. The UE may then send SSB measurement report to the gNB, including RSRP of the N best SSB (or wide) beams measured by the UE.

Step 2: A pre-trained ML model 520 is transferred or transmitted from the gNB 410 to the UE 512. Pre-trained may indicate that the ML model has been previously trained, e.g., by another entity, such as by the gNB. The ML model may be downloaded as a file using dedicated AI/ML DL signalling messages, e.g., which use the best SSB beam identified during Step 1. The ML model may be installed and enabled (where the ML model is running or executing, or being executed by a processor or other circuitry) on the UE 512.

Step 3: Step 3 may include Step 3A and Step 3B. Step 3A may include ML model inference, and may include the UE obtaining or determining ML model output (a beam index and estimated or predicted AoA) for one or more gNB transmit narrow beams based on the SSB beam signal measurements and UE position information. Step 3B may include the UE determining a UE receive narrow (e.g., CSI-RS) beam for each of the or more gNB transmit narrow beams (beam index and AoA) determined at Step 3A (output by the ML model 520).

For Step 3A, at the UE, the set of N RSRP measurements from SSB beams recorded during Step 1 are combined with UE position (positioning or location) information such as latitude and longitude coordinates (obtained with GNSS-based methods, such as Global Positioning System methods, or any other positioning methods at the UE side) and vertical component (if available) obtained from UE device sensors. Then, the aggregated data is used as input of the ML model. Therefore, the UE device executes the ML model inference and saves the results. Input to ML model: N RSRP measurements of N best SSB beams and UE position information; Output of ML model is beam indices of K (e.g., K=1, 2, . . . or 5 (or other number)) best transmit beams, and estimated (or ML model predicted) AoA for each of those beams.

The AoA obtained by UE 512 from the ML model 520 output may be expressed in global coordinate system and the UE may require a transformation matrix signalled by the gNb to transform the AoA from global coordinate system to a local coordinate system. Alternatively, the gNB 512 may train the ML model to predict the AoA in the UE local coordinate system, and this case the AoA may be used directly.

In Step 3B, for each of the K best beams (beam index and estimated AoA) output by ML model 520, the UE selects a UE receive narrow (e.g., CSI-RS) beam of a codebook that is closest to the estimated AoA. Thus, for each of the K best beams (beam index and estimated AoA for each of these K best beams) output by ML model 520, the UE 512 may determine or select a UE receive narrow beam from a beam codebook (a set of beams, each beam with its own AoA), where the selected UE receive narrow (e.g., CSI-RS) beam is the beam in (or from) the beam codebook that has an AoA that most closely matches the estimated AoA of the beam output from (or predicted by) the ML model 520. There may be a different UE receive narrow beam selected or determined by the UE 512 (e.g., based on the codebook) for each of the AoAs output or predicted by the ML model 520. Thus, for example, UE 512 may select the beam of the codebook based on the minimum (or least) angular separation between the predicted AoA (output by ML model 520) and the angular direction (or AoA) of each of the beams within the UE beam codebook. These selected (e.g., from the codebook, based on minimum angular separation) UE receive narrow beams are the UE receive narrow beams associated with each of the K best gNB transmit narrow beams output by the ML model 520.

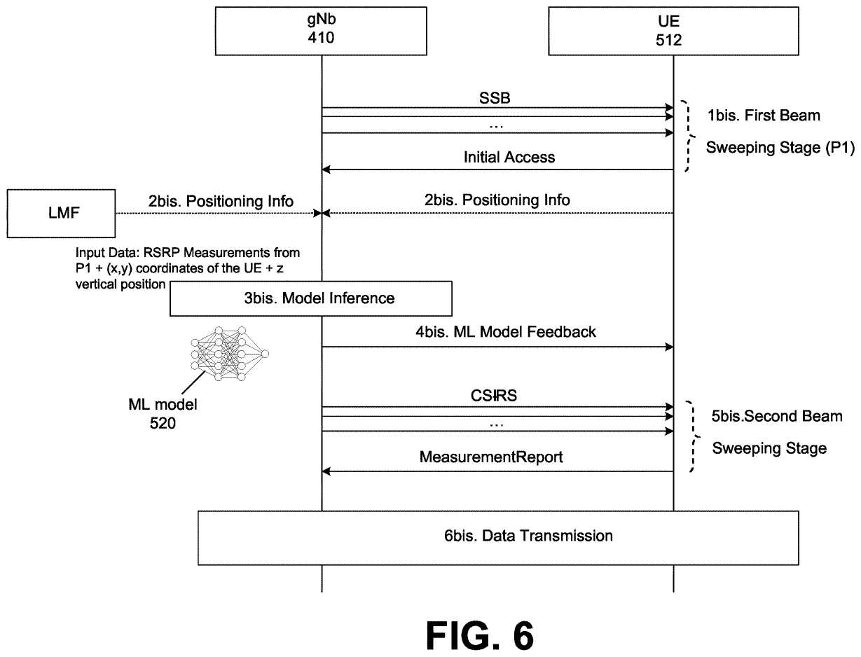

The gNB and/or UE may later determine which of the K gNB transmit narrow (e.g., CSI-RS) beams are the best, since the UE and gNB may typically only use the best beam pair for communication (e.g., the best of the K gNB transmit narrow beams, and the associated UE receive narrow (e.g., CSI-RS) beam. However, the gNB and UE may then perform further steps to determine which of these K gNB transmit narrow beams is the best (e.g., having a highest RSRP as measured by the UE), per steps below and FIG. 6.

UE 512 may determine beam weights two ways: First, the UE 512 may calculate the beam weights based on the estimated AoA (predicted by ML model 520), e.g., UE may determine or directly calculate the antenna weights to be applied to the antenna system to form a beam in the direction of the estimated AoA. Or, if a discrete or limited set of beams is used by the UE (e.g., a codebook or set of specific beams, each with a different AoA and set of antenna weights), then the UE 512 can select the beam from the beam codebook that has an AoA that most closely matches the AoA estimated or predicted by the ML model 520 (e.g., UE 512 selects 1 of the M beams in codebook that is closest to the AoA output by ML model 520).

Step 4: The UE 512 may send the gNB 410 a ML model feedback message indicating the K best CSI-RS beam indexes obtained from ML-model output. (It is not necessary to send the AoAs to the gNB). This message at Step 4 may include a list of K beam (CSI-RS) indexes, i.e., [\hat{l}⁽¹⁾, \hat{l}⁽²⁾, . . . , \hat{l}^{(K)}] that require beam refinement throughout CSI-RSs transmission (or through gNB narrow beam sweeping, at Step 5.

Step 5: During the second stage of beam sweeping, the gNB sweeps through the set of K best gNB transmit narrow beams (indicated in the message sent at Step 4, transmitting CSI-RSs/beam for each of the K best gNB narrow transmit beams indicated in the received message from the UE at Step 4). The UE receives a reference signal(s) (e.g., CSI-RS) via each of the K gNB narrow transmit beams, using the associated UE receive narrow beam for each of the K gNB narrow transmit beams. As noted, the associated UE receive narrow beam may be determined as the beam from the codebook (or set of beams) having an AoA that most closely matches the estimated AoA output by the ML model 520 for that gNB transmit narrow beam. The UE adapts (changes or adjusts) the UE receive narrow beam direction according to the AoA of the selected or associated UE receive narrow beam (e.g., of the selected codebook beam), for each beam of the sequence of the K best gNB transmit narrow beams transmitted by the gNB. UE 512 measures RSRP (or performs other signal measurement) of each transmit/receive beam pair (where a beam pair includes the gNB narrow transmit beam and the associated UE receive narrow beam, for the K best gNB transmit narrow beams output by the ML model 520 and transmitted by the gNB 410). At the end of this stage, the UE identifies the maximum or highest RSRP value from the list of K measurements, to select the best gNB transmit narrow beam among the K gNB transmit narrow beam. Thus, the UE may retrieve and stores the AoA (of the associated UE receive narrow beam) of the best gNB transmit narrow beam. Also at Step 5, as shown in FIG. 5, the UE 512 transmits a beam measurement report to the gNB 410 that identifies the beam (e.g., indicating the beam index) of the best (having a highest RSRP as measured by the UE) gNB transmit narrow (e.g., CSI-RS) beam.

Step 6: The gNB 410 initiates the data transmission (transmits data to the UE 512) in DL (downlink) (or may receive data from UE in UL (uplink)) using the best gNB transmit narrow beam indicated to the gNB in Step 5. The UE may receive this data from the gNB using the UE receive narrow beam (that was stored by the UE 512) associated with the best gNB transmit narrow beam. These two beams form a beam pair that may be used for data transmission between the gNB and UE (for uplink and/or downlink transmissions).

FIG. 6 is a diagram illustrating operation of a gNB or network node. In FIG. 6, the ML model is enabled (e.g., is installed and running or is being executed by the gNB by a processor or other circuitry) on the gNB.

### Model Inference at the gNB Side

With respect to FIG. 6, the ML model inference (e.g., ML model 520 outputs a label or set of outputs based on ML model inputs, based on its training or pre-training) and use at the gNB or network node is described, providing some details of the main steps, and highlighting the differences from the operation of the ML model inference at the UE shown in FIG. 5.

Step 1 bis: Same as Step 1 in FIG. 5.

Step 2 bis: The gNB 410 requests the UE location (or UE position information) from the UE or with network-based positioning methods. gNB 410 may receive the position information of the UE 512 from the UE, from a LMF, or using other technique.

Step 3 bis: The gNB 410 uses the set of N RSRP measurements from SSB or wide beams determined and stored during Step 1 and the UE position information acquired during Step 2bis as inputs of the ML model 520. Therefore, the gNB 410 executes the ML model inference and saves the ML model outputs or results. Step 3bis may include ML model inference, and may include the UE obtaining or determining ML model output (a beam index and estimated or predicted AoA) for one or more gNB transmit narrow (e.g., CSI-RS) beams based on the SSB beam signal measurements and UE position information. Therefore, the UE 512 executes the ML model inference and saves the results. Inputs to ML model 520 may include: RSRP measurements of N best SSB beams and UE position information; Output of ML model 520 may include beam indices of K (e.g., K=1, 2, or 5 (as in Table 2) or other number) best gNB narrow transmit beams, and estimated (or ML model predicted) AoA for each of those beams. The K best beam indexes are used by the gNB to select the gNB transmit narrow beams during the next beam refinement stage.

The AoAs of the K best beams are transmitted to the UE side. The AoA obtained from the ML model output may be expressed in global coordinate system and the UE may require a transformation matrix, which may be signalled by the gNB 410 to UE 512 to transform the AoA from a global coordinate system to the UE local coordinate system. Alternatively, the gNB 512 may convert the AoA to a local coordinate system at the gNB side, using the device orientation communicated by the UE to compute the transformation matrix.

Then, the UE 512 may select the UE receive narrow (e.g., CSI-RS) beam of the codebook that most closely matches the estimated or predicted AoA indicated by the gNB 410 (e.g., based on a minimum angular separation between the predicted AoA in local coordinates system and the angular direction of each receive (Rx) beam within the UE codebook). The UE can select a UE receive narrow (e.g., CSI-RS) beam, e.g., based on one of two ways noted above, either directly using the beam of the estimated AoA, and calculating antenna weights, or by using the codebook (or discrete set of beams) beam (and associated antenna weights) that has an AoA that most closely matches the estimated or predicted AoA received from the gNB 410. Fixed or known formulas, or a lookup table, may be used to calculate beam weights (e.g., an amplitude and a phase for each beam weight, to be applied to the antenna system) based on the AoA, e.g., such as in a case where the UE is able to provide a large number of beams or beam directions. If only a limited or fewer number of discrete beam directions (and sets of beam weights) may be used by the UE, then a codebook may advantageously be used, for example.

Step 4 bis: The gNB 410 sends to the UE 512 the ML model feedback message indicating the AoAs of the K best beams obtained from ML-model output. This message may include a list of K AoAs, i.e., [ [symbol] , [symbol] , . . . , [symbol] ] to be used by the UE 512 to receive and measure RSRP of received signals during the refinement stage of 5bis.

Step 5 bis: During the second stage of beam sweeping, the gNB 410 sweeps through the set of gNB transmit narrow beams corresponding to the K best predicted. The UE adapts the UE receive narrow beam direction according to the AoA value in the sequence of the K AoAs values contained in the ML model feedback message transmitted in Step 4bis (or according to the codebook beam that most closely matches the AoA values sent to the UE). At the end of this stage, the UE 512 identifies the best UE receive narrow beam from RSRP measurements and reports the best beam indexes to the gNB 410, and identifies the best gNB narrow beam from RSRP measurements. Then, the gNB 410 receives from UE the measurement report including an index or indexes, which identify the best gNB transmit narrow beam(s).

Step 6 bis: The gNB 410 initiates the data transmission in DL (or UL) using the best gNB transmit narrow beam index reported in Step 5bis, while the UE 512 uses the best receive narrow beam found in Step 5bis. The gNB 410 initiates the data transmission (transmits data to the UE 512) in DL (downlink) (or may receive data from UE in UL (uplink)) using the best gNB transmit narrow beam reported by to in Step 5bis. The UE 512 may receive this data from the gNB 410 using the UE receive narrow beam associated with the best gNB transmit narrow beam. These two beams form a beam pair that may be used for data transmission between the gNB 410 and UE 512 (for uplink and/or downlink transmissions.

### Wireless Network

An illustrative wireless network may include a sectorized deployment of gNBs (or network nodes) to cover an outdoor area, and which may include buildings. The gNBs may be equipped with a rectangular array formed by A^{H}×A^{V} antennas spaced half-wavelength in both horizontal and vertical dimensions with two polarizations each. A set of UEs may be equipped with one or more rectangular arrays formed by B^{H}×B^{V} antenna each with antenna spacing of half-wavelength in both horizontal and vertical dimensions and having two polarizations each. The UEs may be located outdoor or inside buildings distributed on different floors. The UE locations may be expressed in 3D coordinates as (xᵢ, yᵢ, zᵢ), where the index i identifies the UE.

The DL (downlink) transmission (from gNB 410 to UE 512) may be based on beamforming. At the gNB 410, the beam (gNB transmit beam, for DL transmission) may be selected from a predefined codebook of size W expressed as V_{TX}={v₁, v₂, . . . , v_{w}}, which covers both azimuth and elevation directions. A subset of V_{TX} that includes N SSB (or N wide) beams, forms the set of wide beams used in P1. For beam refinement procedure P2, a set of narrow (e.g., CSI-RS) beams may be used, e.g., with size M_{TX}, that may be inside the angular space of the SSB beam adopted or selected in procedure P1. At the UE side, a fixed size codebook may be used, and may be expressed as U_{RX}={u₁, u₂, . . . , u_{M}_{_{RX}}} contains the set of UE beams with dimension M_{RX}, covering both azimuth and elevation directions.

### Training Phase

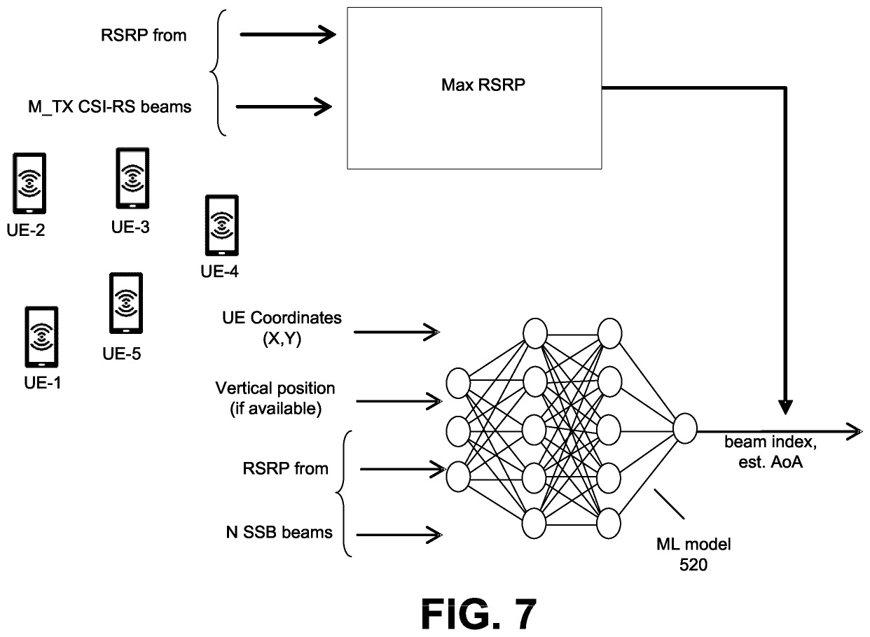

FIG. 7 is a diagram illustrating training of a machine learning (ML) model. The ML (machine learning) model 520 may be trained given a dataset collected from s UEs placed in different positions of the gNB sector and reporting each one multiple measurements in time. The ML model can be implemented in different forms, such as DNN (deep neural network), FNN (feedforward neural network) or CNN (convolutional neural network). In addition, the ML model architecture may be formed by single or multiple layers. The ML model input data may be as follows. The input data (inputs to the ML model 520) may be considered a vector X∈ [symbol] that includes:
1) the position information of the UE, e.g., the estimated 2D (two dimensional) coordinates of the UE position (\hat{x}ᵢ, ŷᵢ), including the vertical location of the UE, i.e., \hat{z}ᵢ; and,
2) the RSRP (reference signal receive power) signal measurements measured and reported by the UE during the procedure P1 on the set of (e.g., SSB or wide) beams {v₁, v₂, . . . , v_{N}} of size N. After performing random access procedure, the UE may measure RSRP values to the gNB of the best N SSB beams received from the gNB, wherein such RSRP values may be used as inputs to the ML model 520.

Using, as inputs to the ML model 520, the combination of both RSRP measurements from P1 and the UE position information may increase or improve the robustness of the beam and AoA prediction in case the UE position information becomes unreliable. In addition, N may depend on the size of the wide-beam codebook at the gNB and modifies the ML Model input data. The ML model 520 may be specific for a gNB GoB configuration.

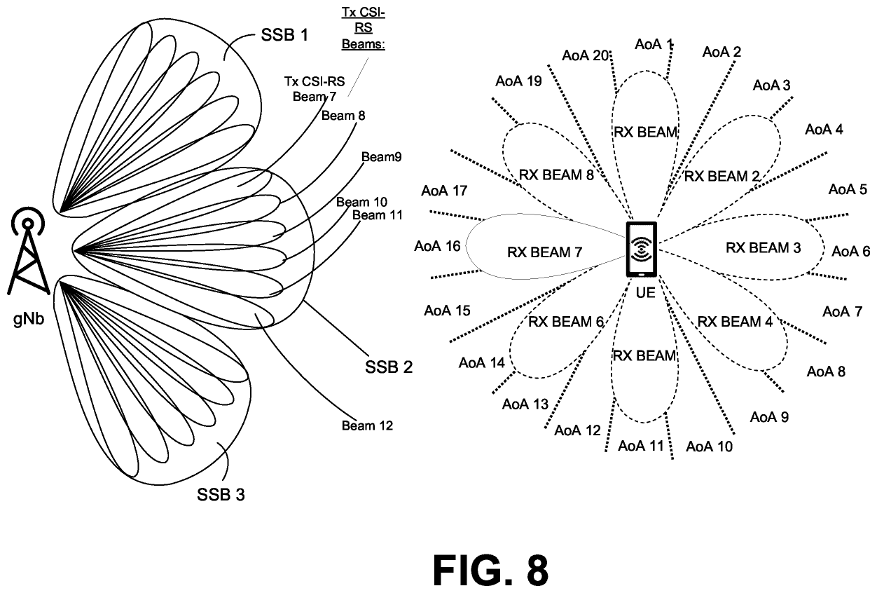

FIG. 8 is a diagram illustrating gNB beams and UE beams. As shown in FIG. 8, a fixed receive beam may be used or assumed during P2 to identify the best gNB transmit narrow beam in the training phase. Then, during P3, the gNB may transmit on a fixed transmit (Tx) narrow beam while the UE sweeps the receive beam measuring the RSRP of all the receive beams (M_{RX}) and estimating the AoA for each one. As shown in FIG. 8, at the left side is the gNB codebook with N=3 SSB beams (broad beams) and 6 CSI-RS beams for each SSB beam. At the right-side, the UE codebook and AoA estimation are shown with the fixed beam pointing in the direction of Rx beam 7.

Thus, the UE may record or store a report like the one described in Table 1, containing M−1 rows, where M is given by the number of transmit (Tx) narrow beams in P2 (M_{TX}) plus the number of receive (Rx) beams in P3 (M_{RX}). Table 1 includes a list of CSI-RS measurements executed by the UE during P2 and P3 in the ML model training. The UE measures the RSRP of the Tx Beam and estimated AoA. The Rx (receive) beam can be excluded from the report as the ML model does not require this information. The best transmit/receive (Tx/Rx) beams based on the maximum RSRP is identified in Table 1. Thus, during training phase (for pre-training the ML model), the UE may send back (transmits) to the gNB the best beam index and the associated AoA. At the gNB side, the best beam index is mapped to a Tx narrow beam, while the AoA is mapped to a discrete value AoA_{w}_{_{RX}} which is selected based on a predefined grid of size W_{RX} defined independently of the number of Rx beams. The ML model may use the estimated AoA, which makes the ML model applicable to different configurations of the grid of beams. Therefore, the receive beam index, which is specific for a configuration of the grid of beams of the user device, may be excluded from the report. During ML model training, the indices of the best Tx beam and associated AoA are used as labels (outputs to be trained) and can be expressed as:

$$< {l}_{TX}^{*} , {AoA}_{{w}_{RX}}^{*} > = {arg max}_{{{l}_{TX} ∈ \{ 1 , .. , {M}_{TX} \}}_{{l}_{RX} ∈ \{ 1 , .. , {M}_{RX} \}}} {RSRP}_{<} {v}_{{l}_{TX}} , {u}_{{l}_{RX} >}$$

TABLE 1

| | Tx CSI- | Rx | AoA | |
|---|---|---|---|---|
| | RS Beam | Beam | Grid Id | RSRP |
| CSI-RS 1 | 7 | 7 | 16 | RSRP 1 |
| CSI-RS 2 | 8 | 7 | 16 | RSRP 2 |
| CSI-RS 3 | 9 | 7 | 16 | RSRP 3 |
| CSI-RS 4 | 10 | 7 | 16 | RSRP 4 |
| CSI-RS 5 | 11 | 7 | 16 | RSRP 5 |
| CSI-RS 6 | 12 | 7 | 16 | RSRP 6 |
| CSI-RS 7 | 10 | 1 | 1 | RSRP 7 |
| CSI-RS 8 | 10 | 2 | 4 | RSRP 8 |
| CSI-RS 9 | 10 | 3 | 6 | RSRP 9 |
| CSI-RS 10 | 10 | 4 | 8 | RSRP 10 |
| CSI-RS 11 | 10 | 5 | 11 | RSRP 11 |
| CSI-RS 12 | 10 | 6 | 13 | RSRP 12 |
| CSI-RS 13 | 10 | 8 | 18 | RSRP 13 |

With respect to FIG. 8, on the left side is the gNB codebook with N=3 SSB beams (broad beams) and 6 CSI-RS beams for each SSB beam. At the right-side, the UE codebook and AoA estimation are shown with the fixed beam pointing in the direction of Rx beam 7.

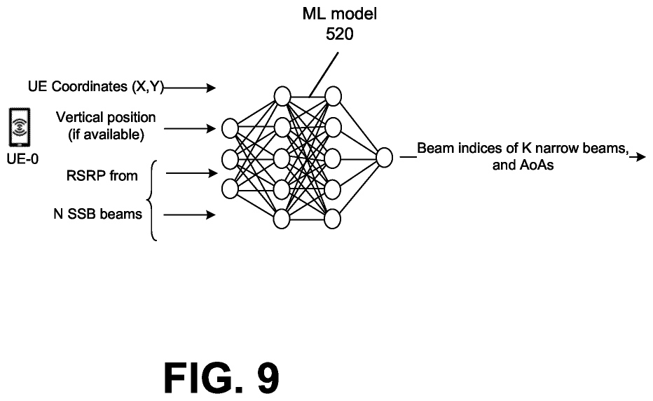

FIG. 9 is a diagram illustrating ML model inference phase at a UE or user device. ML model training may use several data samples with input data. Given the size of the ML-output layer expressed as L=M_{TX}×W_{RX}, the categorical cross-entropy loss function to use can be expressed as:

$$Loss = - {\sum }_{l = 1}^{L} {y}_{l} log ( {\hat{y}}_{l} )$$

Where the l-th ML model output yₗ corresponds to the 2-elements vector

$$< {l}_{TX}^{( l )} , {AoA}_{{w}_{RX}}^{( l )} > .$$

Where lₜₓ is a beam index, and AoA is the estimated or predicted angle of arrival.

### Inference Phase:

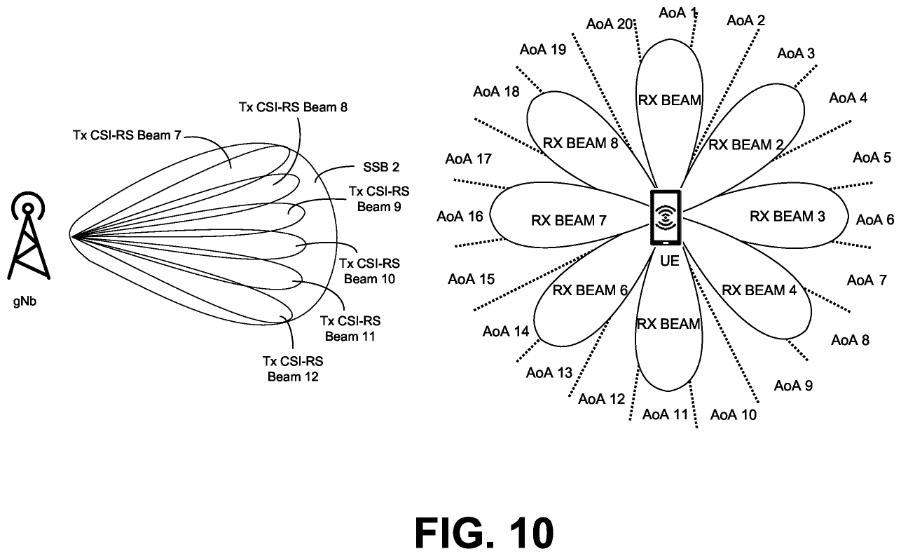

FIG. 10 is a diagram illustrating a representation of gNB and UE codebooks for the second beam sweeping stage. FIG. 10 illustrates examples of gNB and UE codebooks with the list of transmit (Tx) CSI-RS beams and AoA IDs (identifiers) that may be used for the second beam sweeping stage. The trained ML model may be deployed online to predict the best beam pair used by gNB/UE data transmission. As shown in FIG. 9, the input of the ML model the data collected for a single UE, whereas the ML model output can be expressed as:

$$< {\hat{l}}_{TX}^{( 1 )} , >= arg {max}_{l ∈ \{ 1 , .. , L \}} {P}_{l}$$

Where Pₗ=P(y=l|X} represents the probability of picking the l-th ML model output value given the ML model input vector X.

From the ML model output, the UE or gNB may use the predictions of the 2^{nd}, 3^{rd} and K^{th} beam and AoA pairs that have probabilities expressed as P_{\hat{l}}_{⁽¹⁾}>P_{\hat{l}}_{⁽²⁾}>P_{\hat{l}}_{⁽²⁾}> . . . >P_{\hat{l}}_{^{(K)}}.

Therefore, the ML model output may include a list of 2-elements vectors:

[<\hat{l}_{TX}⁽¹⁾, [symbol] >, <\hat{l}_{TX}⁽²⁾, [symbol] >, . . . , <\hat{l}_{TX}^{(K)}, [symbol] >] corresponding to [symbol] the best K gNB narrow Tx (transmit) beam indexes and associated estimated (or predicted) AoAs. Next, as shown in FIG. 10, during the second beam sweeping stage the ML model output is used as follows: 1) the gNB configures the UE to measure (e.g., measure RSRP of signals received via these beams) a set of narrow Tx beams specified in the list of the 2-elements vectors. 2) the UE computes or determines a list of predicted Rx beams from the list of predicted AoAs and uses the sequence of Rx (receive) (e.g., UE receive narrow) beams for measuring the CSI-RSs.

After the second beam sweeping stage, the UE may compile or generate a report like the one shown in Table 2, where each CSI-RS may be measured considering the Tx (transmit) beam and the Rx (receive) beam selected at the UE side based on the predicted AoA. Table 2 illustrates a list of CSI-RS measurements suggested by the ML model output. For each CSI-RS, the predictions from ML model may specify Tx (transmit) CSI-RS beam and AoA Grid Id (indicating AoA of that Tx beam), which may be used at the UE side to establish or determine an associated Rx (receive) beam. The list of measured RSRPs may then used by the UE to find the best Rx beam, and send an indication of the best gNB narrow transmit beam to the gNB, e.g., indicating the CSI-RS identifier associated with the best transmit narrow beam.

TABLE 2

| | Tx CSI- | AoA | Rx | |
|---|---|---|---|---|
| K = 5 | RS Beam | Grid Id | Beam | RSRP |
| CSI-RS 1 | 10 | 16 | 7 | RSRP 1 |
| CSI-RS 2 | 9 | 17 | 7 | RSRP 2 |
| CSI-RS 3 | 11 | 15 | 7 | RSRP 3 |
| CSI-RS 4 | 10 | 16 | 7 | RSRP 4 |
| CSI-RS 5 | 12 | 14 | 6 | RSRP 5 |

The embodiments may include a number of technical advantages, including one or more of the following:

A reduction of beam alignment procedures, reduction in signalling overhead, and/or measurements. Performance gain may be achieved compared to the standard 3GPP beam alignment procedures P2 and P3 as the time required to establish the best gNB/UE beams may be considerably reduced because the proposed method narrowed down the number of CSI-RSs measurements during the beam refinement stage. In addition, the associated signalling overhead is considerably reduced as fewer CSI-RS reports are requested by gNB.

Flexibility to utilize the embodiments with different UE device models, since the same ML model can be applied to different configurations of the UE grid of beams and use the AoA info to select the UE device Rx beam.

Improved ML inference procedure at the UE side as the related embodiment does not require feedback on the UE positioning information to the gNB but considers downloading the ML model to the UE to make predictions locally at the UE side. Thus, avoid sharing UE location information with the gNB.

Significant improvement of the ML model prediction accuracy at the UE side as the combination of UE positioning information and the RSRP measurements from SSB beams used as input data increase the robustness and accuracy of the ML model and speed up the ML model training phase.

As noted, a ML model may be used. In general, one or more nodes (e.g., BS, gNB, eNB, RAN node, user node, UE, user device, relay node, or other node) within a wireless network may use or employ a ML model, e.g., such as, for example a neural network model (e.g., which may be referred to as a neural network, an artificial intelligence (AI) neural network, an AI neural network model, an AI model, a machine learning model or algorithm, or other term) to perform, or assist in performing, one or more functions. Other types of models may also be used. Neural networks or ML models may be or may include computational models used in machine learning made up of nodes organized in layers. The nodes are also referred to as artificial neurons, or simply neurons, and perform a function on provided input to produce some output value. A neural network or ML model requires a training period to learn the parameters, i.e., weights, used to map the input to a desired output. The mapping occurs via the function. Thus, the weights are weights for the mapping function of the neural network. Each neural network model or ML model may be trained for a specific task.

To provide the output given the input, the neural network model or ML model should be trained, which may involve learning the proper value for a large number of parameters (e.g., weights) for the mapping function. The parameters are also commonly referred to as weights as they are used to weight terms in the mapping function. This training may be an iterative process, with the values of the weights being tweaked over many (e.g., thousands) of rounds of training until arriving at the optimal, or most accurate, values (or weights). In the context of neural networks (neural network models) or ML models, the parameters may be initialized, often with random values, and a training optimizer iteratively updates the parameters (weights) of the neural network to minimize error in the mapping function. In other words, during each round, or step, of iterative training the network updates the values of the parameters so that the values of the parameters eventually converge on the optimal values.

Neural network models or ML models may be trained in either a supervised or unsupervised manner, as examples. In supervised learning, training examples are provided to the neural network model or other machine learning algorithm. A training example includes the inputs and a desired or previously observed output. Training examples are also referred to as labeled data because the input is labeled with the desired or observed output. In the case of a neural network, the network learns the values for the weights used in the mapping function that most often result in the desired output when given the training inputs. In unsupervised training, the neural network model learns to identify a structure or pattern in the provided input. In other words, the model identifies implicit relationships in the data. Unsupervised learning is used in many machine learning problems and typically requires a large set of unlabeled data.

According to an example embodiment, the learning or training of a neural network model or ML model may be classified into (or may include) two broad categories (supervised and unsupervised), depending on whether there is a learning “signal” or “feedback” available to a model. Thus, for example, within the field of machine learning, there may be two main types of learning or training of a model: supervised, and unsupervised. The main difference between the two types is that supervised learning is done using known or prior knowledge of what the output values for certain samples of data should be. Therefore, a goal of supervised learning may be to learn a function that, given a sample of data and desired outputs, best approximates the relationship between input and output observable in the data. Unsupervised learning, on the other hand, does not have labeled outputs, so its goal is to infer the natural structure present within a set of data points.

Supervised learning: The computer is presented with example inputs and their desired outputs, and the goal may be to learn a general rule that maps inputs to outputs. Supervised learning may, for example, be performed in the context of classification, where a computer or learning algorithm attempts to map input to output labels, or regression, where the computer or algorithm may map input(s) to a continuous output(s). Common algorithms in supervised learning may include, e.g., logistic regression, naive Bayes, support vector machines, artificial neural networks, and random forests. In both regression and classification, a goal may include to find specific relationships or structure in the input data that allow us to effectively produce correct output data. As special cases, the input signal can be only partially available, or restricted to special feedback: Semi-supervised learning: the computer is given only an incomplete training signal: a training set with some (often many) of the target outputs missing. Active learning: the computer can only obtain training labels for a limited set of instances (based on a budget), and also has to optimize its choice of objects to acquire labels for. When used interactively, these can be presented to the user for labeling. Reinforcement learning: training data (in form of rewards and punishments) is given only as feedback to the program's actions in a dynamic environment, e.g., using live data.

Unsupervised learning: No labels are given to the learning algorithm, leaving it on its own to find structure in its input. Some example tasks within unsupervised learning may include clustering, representation learning, and density estimation. In these cases, the computer or learning algorithm is attempting to learn the inherent structure of the data without using explicitly-provided labels. Some common algorithms include k-means clustering, principal component analysis, and auto-encoders. Since no labels are provided, there may be no specific way to compare model performance in most unsupervised learning methods.

Some further examples will be provided.

Example 1. A method (e.g., FIG. 2) comprising: determining (210, FIG. 2; phase P1 for FIG. 5), by a user device (e.g., UE 512, FIG. 5), signal measurements (e.g., reference signal received power (RSRP) measurements) for signals (e.g., for reference signals, such as synchronization signal block (SSB) reference signals or channel state information-reference signal (CSI-RS) signals) received from a network node (e.g., gNB 410, FIG. 5)) for a plurality of first beams (e.g., for a plurality of wide beams or SSB beams); determining (e.g., 220, FIG. 2), by the user device (e.g. UE 512), a beam index and an estimated angle of arrival (AoA) for one or more network node transmit second beams (e.g., for one or more network node or gNB transmit narrow beams or gNB transmit CSI-RS beams) based on the signal measurements for a set of one or more first beams and position information for the user device; determining (e.g., 230, FIG. 2), by the user device (UE 512) for one or more of the network node transmit second beams, an associated user device receive second beam (e.g., an associated UE receive narrow beam or an associated UE receive CSI-RS beam), wherein the associated user device receive second beam is at least one of a beam from a codebook that has an angle of arrival (AoA) that most closely matches the estimated angle of arrival of the network node transmit second beam, or a beam having beam weights (e.g., amplitude and/or phase, which may be applied to an antenna system) calculated (e.g., based on a lookup table or formula) based on the estimated angle of arrival for the network node transmit second beam; and controlling transmitting (240, FIG. 2), by the user device (e.g., UE 512) to the network node, the beam index for the one or more network node transmit second beams.

For example, the determining (e.g., 220, FIG. 2), by the user device (e.g. UE 512), a beam index and an estimated angle of arrival (AoA) for one or more network node transmit second beams (e.g., for one or more network node or gNB transmit narrow beams or gNB transmit CSI-RS beams) based on the signal measurements for a set of one or more first beams and position information for the user device may include Step 3A (FIG. 5, including ML model inference (for ML model 520, FIG. 5)), including the UE 512 obtaining or determining ML model output (a beam index and estimated or predicted AoA) for one or more gNB transmit narrow beams based on the SSB beam signal measurements and UE position information.

Example 2. The method of example 1, wherein the determining a beam index and an estimated angle of arrival comprises: providing, by the user device, the signal measurements for a set of one or more first beams (e.g., SSB beams) and the position information for the user device (for UE 512) as inputs of a pre-trained machine learning model (e.g., RSRP measurements and UE position information may be provided as inputs to ML model 520, FIG. 5) enabled (e.g., running or executing) on the user device (on UE 512); controlling receiving, by the user device (UE 512) as an output from the pre-trained machine learning model (ML model 520, FIG. 5), a beam index and an estimated angle of arrival for one or more network node transmit second beams (a beam index and estimated AoA is an output of the ML model 520, FIG. 5).

Example 3. The method of any of examples 1-2, further comprising: controlling receiving, by the user device (e.g., UE 512, FIG. 5) from the network node (gNB 410), the pre-trained machine learning model (step 2, FIG. 5, ML model download); selecting, by the user device, the set of one or more first beams based on signal measurements performed by the user device for a plurality of first beams (e.g., step 1, FIG. 5); determining, by the user device, position information for the user device.

Example 4. The method of any of examples 1-2, further comprising: determining, by the user device (UE 512, FIG. 5) based on signal measurements of the one or more network node transmit second beams received from the network node, a best or a selected network node transmit second beam; and controlling transmitting, by the user device to the network node, a beam index (e.g., see step 5 of FIG. 5) of the best or the selected network node transmit second beam. For example, UE 512 measures RSRP (or performs other signal measurement) of each transmit/receive beam pair (where a beam pair includes the gNB narrow transmit beam and the associated UE receive narrow beam, for the K best gNB transmit narrow beams output by the ML model 520 and transmitted by the gNB 410). At the end of this stage, the UE identifies the maximum or highest RSRP value from the list of K measurements, to select the best gNB transmit narrow beam among the K gNB transmit narrow beam. Thus, the UE may retrieve and store the AoA (of the associated UE receive narrow beam) of the best gNB transmit narrow beam. Also at Step 5, as shown in FIG. 5, the UE 512 transmits a beam measurement report to the gNB 410 that identifies the beam (e.g., indicating the beam index) of the best (having a highest RSRP as measured by the UE) gNB transmit narrow (e.g., CSI-RS) beam.

Example 5. The method of example 4 wherein the determining, by the user device (e.g., UE 512) based on signal measurements of the one or more network node transmit second beams received from the network node, a best or a selected network node transmit second beam comprises: performing the following for each of the one or more one network node transmit second beams: controlling receiving, by the user device from the network node, a signal via a beam pair that includes the network node transmit second beam and the associated user device receive second beam; and measuring, by the user device, a signal parameter of the received signal; and selecting, by the user device, among the plurality of network node transmit second beams, a best or a selected network node transmit second beam based on the measuring. For example, see step 5 of FIG. 5. The UE adapts (changes or adjusts) the UE receive narrow beam direction according to the AoA of the selected or associated UE receive narrow beam (e.g., of the selected codebook beam), for each beam of the sequence of the K best gNB transmit narrow beams transmitted by the gNB. UE 512 measures RSRP (or performs other signal measurement) of each transmit/receive beam pair (where a beam pair includes the gNB narrow transmit beam and the associated UE receive narrow beam, for the K best gNB transmit narrow beams output by the ML model 520 and transmitted by the gNB 410). At the end of this stage, the UE identifies the maximum or highest RSRP value from the list of K measurements, to select the best gNB transmit narrow beam among the K gNB transmit narrow beam. Thus, the UE may retrieve and stores the AoA (of the associated UE receive narrow beam) of the best gNB transmit narrow beam. Also at Step 5, as shown in FIG. 5, the UE 512 transmits a beam measurement report to the gNB 410 that identifies the beam (e.g., indicating the beam index) of the best (having a highest RSRP as measured by the UE) gNB transmit narrow (e.g., CSI-RS) beam.

Example 6. The method of any of examples 1-5, further comprising: controlling receiving data (e.g., see step 6, FIG. 5), by the user device from the network node, via a beam pair that includes the best or selected network node transmit second beam and the associated user device receive second beam.

Example 7. The method of any of examples 2-6, wherein the pre-trained machine learning model (e.g., ML model 520) is not specific to the user device, is general for multiple user devices, and is trained based on information provided by a plurality of user devices.

Example 8. The method of any of examples 1-7, wherein the angle of arrival (AoA) comprises both an azimuth angle of arrival and an elevation angle of arrival, the method further comprising: converting, by the user device, the angle of arrival from a first coordinate system to a second coordinate system based on a transformation matrix. For example, the AoA obtained by UE 512 (FIG. 5) from the ML model 520 output may be expressed in global coordinate system and the UE may require a transformation matrix signalled by the gNb to transform the AoA from global coordinate system to a local coordinate system. Alternatively, the gNB 512 may train the ML model to predict the AoA in the UE local coordinate system, and this case the AoA may be used directly.

Example 9. The method of any of examples 2-8, further comprising: controlling transmitting, by the user device (UE 512), information to the network node (gNB 410, FIG. 5) to enable the network node to perform pre-training of the machine learning model (pre-training, shown in FIG. 4 of ML model 520).

Example 10. The method of any of examples 1-9, wherein: the first beams (e.g., SSB beams) comprise wide beams; and, the second beams (e.g., SSB beams or CSI-RS beams, or narrow beams) comprise narrow beams that are narrower than the wide beams.

Example 11. The method of any of examples 1-10, wherein: the first beams comprise wide beams; the network node transmit second beams comprise narrow beams; and the user device receive second beam comprises a narrow beam; wherein wide beams have a wider beam width than the narrow beams.

Example 12. The method of any of examples 1-11, wherein: the first beams comprise synchronization signal block (SSB) beams or channel state information-reference signal (CSI-RS) beams; the network node transmit second beams comprise channel state information-reference signal (CSI-RS) beams; and the user device receive second beam comprises a channel state information-reference signal (CSI-RS) beam.

Example 13. The method of any of examples 1-12, wherein the signal measurements comprise a reference signal receive power (RSRP) measurement of reference signals.

Example 14. An apparatus (e.g., apparatus 1200) comprising means (e.g., processor 1204, memory 1206, and/or wireless transceiver 1202A) for performing the method of any of examples 1-13.

Example 15. A non-transitory computer-readable storage medium (e.g., 1206) comprising instructions stored thereon that, when executed by at least one processor (e.g., processor 1204), are configured to cause a computing system to perform the method of any of examples 1-13.

Example 16. An apparatus comprising: at least one processor; and at least one memory including computer program code; the at least one memory and the computer program code configured to, with the at least one processor, cause the apparatus at least to perform the method of any of examples 1-13.

Example 17. An apparatus comprising: at least one processor (e.g., processor 1204); and at least one memory (e.g., 1206) including computer program code; the at least one memory and the computer program code configured to, with the at least one processor, cause the apparatus at least to: determine, by a user device, signal measurements for signals received from a network node for a plurality of first beams; determine, by the user device, a beam index and an estimated angle of arrival for one or more network node transmit second beams based on the signal measurements for a set of one or more first beams and position information for the user device; determine, by the user device for one or more of the network node transmit second beams, an associated user device receive second beam, wherein the associated user device receive second beam is at least one of a beam from a codebook that has an angle of arrival that most closely matches the estimated angle of arrival of the network node transmit second beam or a beam having beam weights calculated based on the estimated angle of arrival for the network node transmit second beam; and control transmitting, by the user device to the network node, the beam index for the one or more network node transmit second beams.

Example 18. A method (e.g., see FIGS. 3 and 6) comprising: controlling transmitting (e.g., 310, FIG. 3; phase P1, FIG. 6), by a network node (e.g., LMF or gNB 410) to a user device (UE 512), signals via a plurality of first beams (e.g., step 1bis, FIG. 6, including gNB transmits SSB signals to UE); controlling receiving (320, FIG. 3), by the network node (LMF or gNB 410) from the user device, signal measurements (e.g., RSRP signal measurements, e.g., sent via step 1bis after initial access) for a set of one or more of the first beams (e.g., for SSB beams or wide beams); controlling receiving (e.g., 330, FIG. 3) by the network node, position information (e.g., a position or location of the UE 512, received by gNB or LMF at step 2bis, FIG. 6) for the user device (UE 512); determining, by the network node (LMF or gNB 410), a beam index and an estimated angle of arrival (AoA) for one or more network node transmit second beams based on the signal measurements for the set of one or more first beams and position information for the user device; and controlling transmitting (350, FIG. 3) by the network node to the user device, information indicating the estimated angle of arrival of the one or more network node transmit second beams.

Example 19. The method of example 18, wherein the determining a beam index and an estimated angle of arrival comprises: providing, by the network node, the signal measurements for a set of one or more first beams and the position information for the user device as inputs to a trained machine learning model enabled on the network node; controlling receiving, by the network node as an output from the trained machine learning model, a beam index and an estimated angle of arrival for one or more network node transmit second beams.

Example 20. The method of any of examples 18-19, further comprising: controlling transmitting, by the network node, signals via the one or more network node transmit second beams indicated by the pre-trained machine learning model; and controlling receiving, by the network node from the user device, a beam index of a best or a selected network node transmit second beam of the one or more network node transmit second beams.

Example 21. The method of any of examples 18-20, further comprising: controlling transmitting data, by the network node to the user device, via a beam pair that includes the best or selected network node transmit second beam and an associated user device receive second beam.

Example 22. The method of any of examples 18-21, wherein: the first beams comprise wide beams; the second beams comprise narrow beams that are narrower than the wide beams.

Example 23. The method of any of examples 18-22: the first beams comprise wide beams the network node transmit second beams comprise narrow beams; and the user device receive second beam comprises a narrow beam; wherein wide beams have a wider beam width than the narrow beams.

Example 24. The method of any of examples 18-23, wherein: the first beams comprise synchronization signal block (SSB) beams or channel state information-reference signal (CSI-RS) beams; the network node transmit second beams comprise channel state information-reference signal (CSI-RS) beams; and the user device receive second beam comprises a channel state information-reference signal (CSI-RS) beam.

Example 25. The method of any of examples 18-24, wherein the pre-trained machine learning model is not specific to the user device, and is trained based on information received from a plurality of user devices.

Example 26. The method of any of examples 18-25, further comprising: training, based on information received from a plurality of user devices, a machine learning model to obtain the trained machine learning model.

Example 27. The method of any of examples 18-26, further comprising: receiving, by the network node information from a plurality of user devices, including signal measurements for a set of one or more first beams and position information for the user device; and training, based on information received from the plurality of user devices, the machine learning model to obtain the pre-trained machine learning model.

Example 28. The method of any of examples 18-27, wherein the angle of arrival comprises both an azimuth angle of arrival and an elevation angle of arrival, the method further comprising: converting, by the network node, the angle of arrival from a first coordinate system to a second coordinate system based on a transformation matrix.

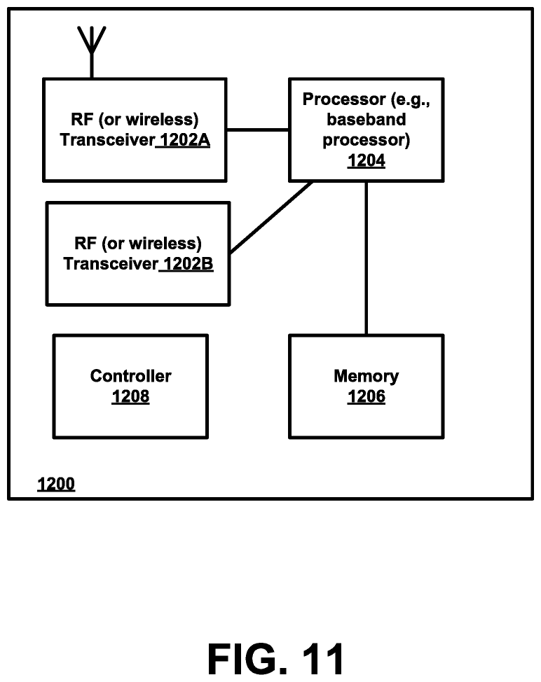

Example 29. An apparatus (e.g., 1200, FIG. 11) comprising means (e.g., processor 1204, memory 1206 and/or transceiver 1202A) for performing the method of any of examples 17-27.

Example 30. A non-transitory computer-readable storage medium (e.g., 1206, FIG. 11) comprising instructions stored thereon that, when executed by at least one processor, are configured to cause a computing system to perform the method of any of examples 18-28.

Example 31. An apparatus (e.g., 1200, FIG. 11) comprising: at least one processor (1204, FIG. 11); and at least one memory (1206) including computer program code; the at least one memory and the computer program code configured to, with the at least one processor, cause the apparatus at least to perform the method of any of examples 18-28.

Example 32. An apparatus (e.g., 1200) comprising: at least one processor (1206); and at least one memory including computer program code; the at least one memory and the computer program code configured to, with the at least one processor (1204, FIG. 11), cause the apparatus at least to: control transmitting, by a network node to a user device, signals via a plurality of first beams; control receiving, by the network node from the user device, signal measurements for a set of one or more of the first beams; control receiving, by the network node, position information for the user device; determine, by the network node, a beam index and an estimated angle of arrival for one or more network node transmit second beams based on the signal measurements for the set of one or more first beams and position information for the user device; and control transmitting, by the network node to the user device, information indicating the beam index and the estimated angle of arrival of the one or more network node transmit second beams.

FIG. 11 is a block diagram of a wireless station or node (e.g., UE, user device, AP, BS, eNB, gNB, RAN node, network node, TRP, or other node) 1200 according to an example embodiment. The wireless station 1200 may include, for example, one or more (e.g., two as shown in FIG. 11) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 11, a controller (or processor) 1208 may execute software and instructions, and may provide overall control for the station 1200, and may provide control for other systems not shown in FIG. 11, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-32. (canceled)

33. A method comprising:
determining, by a user device, signal measurements for signals received from a network node for a plurality of first beams;
determining, by the user device, a beam index and an estimated angle of arrival for one or more network node transmit second beams based on the signal measurements for a set of one or more first beams and position information for the user device;
determining, by the user device for one or more of the network node transmit second beams, an associated user device receive second beam, wherein the associated user device receive second beam is at least one of a beam from a codebook that has an angle of arrival that most closely matches the estimated angle of arrival of the network node transmit second beam, or a beam having beam weights calculated based on the estimated angle of arrival for the network node transmit second beam; and
controlling transmitting, by the user device to the network node, the beam index for the one or more network node transmit second beams.

34. The method of claim 33, wherein the determining a beam index and an estimated angle of arrival comprises:
providing, by the user device, the signal measurements for a set of one or more first beams and the position information for the user device as inputs of a pre-trained machine learning model enabled on the user device;
controlling receiving, by the user device as an output from the pre-trained machine learning model, a beam index and an estimated angle of arrival for one or more network node transmit second beams.

35. The method of claim 33, further comprising:
controlling receiving, by the user device from the network node, the pre-trained machine learning model;
selecting, by the user device, the set of one or more first beams based on signal measurements performed by the user device for a plurality of first beams;
determining, by the user device, position information for the user device.

36. The method of claim 33, further comprising:
determining, by the user device based on signal measurements of the one or more network node transmit second beams received from the network node, a best or a selected network node transmit second beam; and
controlling transmitting, by the user device to the network node, a beam index of the best or the selected network node transmit second beam.

37. The method of claim 33, further comprising:
controlling receiving data, by the user device from the network node, via a beam pair that includes the best or selected network node transmit second beam and the associated user device receive second beam.

38. The method of claim 33, wherein the angle of arrival comprises both an azimuth angle of arrival and an elevation angle of arrival, the method further comprising:
converting, by the user device, the angle of arrival from a first coordinate system to a second coordinate system based on a transformation matrix.

39. The method of claim 33, wherein:
the first beams comprise wide beams;
the second beams comprise narrow beams that are narrower than the wide beams.

40. The method of claim 33, wherein:
the first beams comprise wide beams;
the network node transmit second beams comprise narrow beams; and
the user device receive second beam comprises a narrow beam;
wherein wide beams have a wider beam width than the narrow beams.

41. The method of claim 33, wherein:
the first beams comprise synchronization signal block (SSB) beams or channel state information-reference signal (CSI-RS) beams;
the network node transmit second beams comprise channel state information-reference signal (CSI-RS) beams; and
the user device receive second beam comprises a channel state information-reference signal (CSI-RS) beam.

42. The method of claim 33, wherein the signal measurements comprise a reference signal receive power (RSRP) measurement of reference signals.

43. An apparatus comprising:
at least one processor; and
at least one memory including computer program code;
the at least one memory and the computer program code configured to, with the at least one processor, cause the apparatus at least to:
determine, by a user device, signal measurements for signals received from a network node for a plurality of first beams;
determine, by the user device, a beam index and an estimated angle of arrival for one or more network node transmit second beams based on the signal measurements for a set of one or more first beams and position information for the user device;
determine, by the user device for one or more of the network node transmit second beams, an associated user device receive second beam, wherein the associated user device receive second beam is at least one of a beam from a codebook that has an angle of arrival that most closely matches the estimated angle of arrival of the network node transmit second beam or a beam having beam weights calculated based on the estimated angle of arrival for the network node transmit second beam; and
control transmitting, by the user device to the network node, the beam index for the one or more network node transmit second beams.

44. The apparatus of claim 43, wherein the determining a beam index and an estimated angle of arrival comprises:
providing, by the user device, the signal measurements for a set of one or more first beams and the position information for the user device as inputs of a pre-trained machine learning model enabled on the user device;
controlling receiving, by the user device as an output from the pre-trained machine learning model, a beam index and an estimated angle of arrival for one or more network node transmit second beams.

45. The apparatus of claim 43, further being caused to:
control receiving, by the user device from the network node, the pre-trained machine learning model;
select, by the user device, the set of one or more first beams based on signal measurements performed by the user device for a plurality of first beams;
determine, by the user device, position information for the user device.

46. The apparatus of claim 43, further being caused to:
control receiving data, by the user device from the network node, via a beam pair that includes the best or selected network node transmit second beam and the associated user device receive second beam.

47. The apparatus of claim 43, wherein:
the first beams comprise wide beams;
the second beams comprise narrow beams that are narrower than the wide beams.

48. The apparatus of claim 43, wherein:
the first beams comprise wide beams;
the network node transmit second beams comprise narrow beams; and
the user device receive second beam comprises a narrow beam;
wherein wide beams have a wider beam width than the narrow beams.

49. The apparatus of claim 43, wherein:
the first beams comprise synchronization signal block (SSB) beams or channel state information-reference signal (CSI-RS) beams;
the network node transmit second beams comprise channel state information-reference signal (CSI-RS) beams; and
the user device receive second beam comprises a channel state information-reference signal (CSI-RS) beam.

50. The apparatus of claim 43, wherein the signal measurements comprise a reference signal receive power (RSRP) measurement of reference signals

51. The apparatus of claim 43, further being caused to:
determine by the user device based on signal measurements of the one or more network node transmit second beams received from the network node, a best or a selected network node transmit second beam; and
control transmitting, by the user device to the network node, a beam index of the best or the selected network node transmit second beam.

52. The apparatus of claim 43, wherein the angle of arrival comprises both an azimuth angle of arrival and an elevation angle of arrival, the apparatus further being caused to:
convert, by the user device, the angle of arrival from a first coordinate system to a second coordinate system based on a transformation matrix.
